(19) United States
(12) Patent Application Publication
(10) Pub. No.: US 2003/0025605 A1
(43) Pub. Date: Feb. 6, 2003

(54) Vigilant dwelling

(76) Inventor: Jacob Edward Prins, Famham Royal (GB)

Correspondence Address: ROBERT W. J. USHER, PATENT AGENT, 1133 BROADWAY, #1515, NEW YORK, NY, 10010

(21) Appl. No.: 10/145,246

(22) Filed: May 14, 2002

(30) Foreign Application Priority Data
Jul. 31, 2001 (GB) 0118615.4
Feb. 22, 2002 (GB) 0204178.8

(51) Int. Cl. G08B 23/00

(52) U.S. Cl. 340/573.1; 340/573.4; 340/573.5; 340/573.6; 340/573.7; 340/531

(57) ABSTRACT

A dwelling permitting extended self reliance for compromised individuals is equipped with monitors for the position of the individual, sensors for the state of domestic equipment, the external environment television cameras, a controller, personal alarm, telephone, access to a remote (Internet) site where a remote user monitors the condition of occupants and the dwelling state and issue instructions to the dwelling, to be picked up and obeyed by the dwelling on next dwelling access. The dwelling can switch off/on equipment including electric stoves, electric fires and electric lights; telephone for help if a personal alarm is used; audibly address the occupant; open and close curtains, windows and doors; and advise the occupant of omitted acts. Various electric main supply sockets withhold electrical supply from the socket until plug insertion. The remote user can monitor the activity and state of any monitored and/or controlled item within the dwelling.

### FIELD OF THE INVENTION

The present invention relates to methods and apparatus for automatic control and safekeeping of dwellings, being particularly directed to apparatus for assisting and keeping safe very young, very old, mentally vague, physically incapacitated, mentally incapacitated, mentally challenged, frail and unwell individuals, hereinafter known as compromised individuals. It most particularly relates to methods and apparatus apt for use by, or in the presence of, such individuals.

### BACKGROUND OF THE INVENTION

Improvements in healthcare have resulted in a demographic age shift in the population. Persons are living longer. Increased age means that physical or mental conditions which were relatively rare in a population of a lesser mean age of death are now quite common. Such conditions include progressive dementia and forgetfulness, deteriorating senses, decreased mobility and an enhanced risk of suffering an isolating injury if left alone. Improved social and medical care has also meant that individuals with learning difficulties, genetic defects or personality disorders, who would either not have survived, or would have been institutionalised, are now in a position to lead long lives in the community, despite the increased risk of accident, injury or consequences of carelessness. The present invention seeks to provide means for avoiding these problems. Any one of these conditions does not necessarily mean that the sufferer is incapable of an independent lifestyle. It does, however, mean that a great deal of attention must be given to the individual to ensure that they do not present a hazard to themselves. At a mild level, a sufferer can be cared for by living with family members, should family members be available and capable of the task. At a more severe level, professional social services are required, which is expensive for the community. At even more severe levels, the sufferer may need to be taken into residential care, which robs the sufferer of their independence and imposes a very high community or family cost. The present invention seeks to provide means whereby an individual can sustain independent life for a longer period and with less assistance from others.

Forgetfulness is a great problem with progressing age. A heating or cooking appliance, remaining switched on but unattended and forgotten, can pose considerable risk of causing a building fire or burning an individual who, for example, has fallen asleep in front of the fire or who attempts to lift a cooking pot from a stove when the pot has been (unintentionally and by forgetfulness)left to boil dry. Forgetting to extinguish electric lights or to switch off electrical appliances can have a surprisingly expensive effect on utility bills. Windows and doors (unknowingly) left open, can place an individual's safety at risk and invite theft or vandalism. The present invention seeks to ameliorate the effects of forgetfulness.

Frailty can mean that an individual, even though alert, can be unable to perform elementary tasks. The present invention seeks automatically to provide basic services.

The same problems as exist for some aging persons can also exist for infants, young persons, individuals with learning difficulties and sufferers from personality disorders. The present invention seeks also to provide methods and apparatus apt for such individuals.

Essentially, the present invention seeks to provide an individual with an automatic mentoring, monitoring and physical assistance service which will enable them to continue in an independent lifestyle.

An individual in charge of an automated dwelling, may not always be present or available to monitor or correct the functioning of the dwelling. The present invention seeks to provide means whereby a dwelling can be monitored and controlled from any point on earth.

### SUMMARY OF THE INVENTION

The present invention seeks to provide services and control of equipment directed towards the well being and welfare of the compromised individual, as well as providing electrical safety for infants and a remotely controllable automated dwellings for other individuals.

The present invention consists in a system for controlling the surroundings of a compromised individual, said system comprising; means to monitor the location of the compromised individual; means to activate equipment in the presence of the compromised individual; and means to de-activate equipment in the absence of the compromised dividual.

The invention further provides that the system can comprise means to monitor the activity of the compromised individual, means to assess the probity of the activity of the compromised individual, and means to direct the activity of the compromised individual towards probity.

The invention further provides that the means to direct the activity of the compromised individual towards probity can comprise means to remind the compromised individual of a necessary action.

The invention further provides that the means to direct the activity of the compromised individual towards probity can comprise means to deny the compromised individual the execution of an action.

The invention further provides that the means to deny the compromised individual the execution of an action can comprise means to monitor the prevailing environmental conditions and to deny the execution of the action if the prevailing environmental conditions are incompatible with the proposed action.

The invention further provides that the means to monitor the prevailing environmental conditions can monitor one, all, or some of: wind speed; ambient temperature; precipitation; and brightness.

The invention further provides that the action, whose execution is deniable as a result of monitoring the prevailing environmental conditions, can include opening of a window.

The invention further provides that the action, whose execution is deniable as a result of monitoring the prevailing environmental conditions, can include deployment of an awning.

The invention further provides that the action, whose execution is deniable as a result of monitoring the prevailing environmental conditions, can include opening of curtains.

The invention further provides that the necessary action, of which the compromised individual can be reminded, can include closing an unattended window.

The invention further provides that the necessary action, of which the compromised individual can be reminded, can include closing an unattended door.

The invention further provides that the necessary action, of which the compromised individual can be reminded, can include closing an unattended gate.

The invention further provides that the necessary action, of which the compromised individual can be reminded, can include return to an unattended appliance.

The invention further provides that means to monitor the location of the compromised individual can comprise passive a infra red detector.

The invention further provides that means to monitor the location of the compromised individual can comprise a pressure mat.

The invention further provides that means to monitor the location of the compromised individual can comprise a closed circuit television camera.

The invention further provides that the equipment, which can be activated in the presence of the compromised individual, can include local lighting.

The invention further provides that the equipment, which can be activated in the presence of the compromised individual, can include local air circulation.

The invention further provides that the equipment, which can be activated in the presence of the compromised individual, can include a local loud speaker.

The invention further provides that the means to de-activate equipment in the absence of the compromised individual can comprises means to disconnect the electricity supply from the electrical outlet powering the equipment.

The invention further provides that the means to disconnect the electricity supply from the electrical outlet powering the equipment can comprise a switch, operable by the insertion of a plug into a socket, to connect the electricity supply to the socket.

The invention further provides that the switch can couple the electricity supply directly to the socket.

The invention further provides that the switch can operate a relay, the relay being operative to couple the electricity supply to the socket.

The invention further provides that the means to disconnect the electricity supply from the electrical outlet powering the equipment can comprise a light path, breakable by the insertion of a plug into a socket, the breaking of the light path causing the operation of a relay to connect the electricity supply to the socket.

The invention further provides that the means to disconnect the electricity supply from the electrical outlet powering the equipment can comprise a bleed current supply through the equipment and a bleed current detector in association with the socket, detection of the flow of bleed current causing the operation of a relay to connect the electricity supply to the socket.

The invention further provides that the bleed current detector can comprise an optical coupler.

The invention further provides that the means to disconnect the electricity supply from the electrical outlet powering the equipment can comprise means to re-connect the electricity supply, operable only in the presence of the individual.

The invention further provides that the means to re-connect the electricity supply, operable only in the presence of the compromised individual, can include a manually operable switch.

The invention further provides that the means to re-connect the electricity supply, operable only in the presence of the compromised individual, can include a passive infra red detector.

The invention further provides that the means to re-connect the electricity supply, operable only in the presence of the compromised individual, can include a pressure mat.

The invention further provides that the means to re-connect the electricity supply, operable only in the presence of the compromised individual, can include a closed circuit television camera.

The invention further provides that the equipment which can be de-activated in the absence of the compromised individual can include an electric fire.

The invention further provides that the equipment which can be de-activated in the absence of the compromised individual can include an electric stove.

The invention further provides that the equipment which can be de-activated in the absence of the compromised individual can include an electric kitchen appliance.

The invention further provides that the equipment which can be de-activated in the absence of the compromised individual can include an electric domestic laundry appliance.

The invention further provides that the equipment which can be de-activated in the absence of the compromised individual can include an electric lamp.

The invention also provides that the system can comprise a controller for monitoring the surroundings and responding thereto to activate and de-activate equipment to promote the safety and well being of the compromised individual.

The invention further provides that the controller can receive an alarm call from the compromised individual, and can respond thereto by summoning help.

The invention further provides that the summoning of help can include the making of a pre-recorded telephone call.

The invention further provides that the making of a prerecorded telephone call can include telephoning telephone numbers on a predetermined list.

The invention further provides that telephoning telephone numbers on a predetermined list can include continuing to telephone numbers on the list until at least one telephone number has been contacted.

The invention further provides monitoring and control means, where a remote user can access a dwelling to determine the status of the dwelling.

The invention further provides that the remote user can adjust the controls in the dwelling.

The invention further provides that the dwelling and the remote user can access a common data site for the dwelling to report status and for the dwelling to receive instructions, and for the remote user to receive a report of status and for the remote user to give instructions.

The invention further provides that the dwelling and the remote user can access the common data site at different times.

The invention further provides that the data site is an Internet site.

### BRIEF DESCRIPTION OF THE DRAWINGS

The invention is further explained, by way of example, by the following description, read in conjunction with the appended drawings, in which:

FIG. 1 is an isometric view of a an exemplary dwelling, according to the present invention,

FIG. 2 is a schematic diagram of the dwelling of FIG. 1.

FIG. 3 is an isometric view of an exemplary room, according to the present invention.

FIG. 4A is a side projection of an awning according to the present invention.

FIG. 4B is a flow chart of the operation of the awning of FIG. 4A.

FIG. 5A is an isometric view of a first type of plug socket, according to the invention.

FIG. 5B is a schematic diagram showing the manner of use of the first type of plug socket of FIG. 5A.

FIG. 6A is an isometric view of a second type of plug socket, according to the invention.

FIG. 6B is a schematic diagram showing the manner of use of the second type of plug socket of FIG. 5A.

FIG. 7A is an isometric view of a third type of plug socket, according to the invention.

FIG. 7B is a schematic diagram showing the manner of use of the third type of plug socket of FIG. 7A.

FIG. 8A is an isometric view of a fourth type of plug socket, according to the invention.

FIG. 8B is a schematic diagram showing the manner of use of the fourth type of plug socket of FIG. 8A.

FIG. 9 is an isometric view of a fifth type of (two pin) plug socket, according to the invention.

FIG. 10 is an isometric view of a sixth type of (two pin) plug socket, according to the invention. And

FIG. 11 is a flow chart of the different activities of the personal computer, the control website and a remote user when monitoring and adjusting the dwelling.

### DESCRIPTION OF PARTICULAR EMBODIMENT

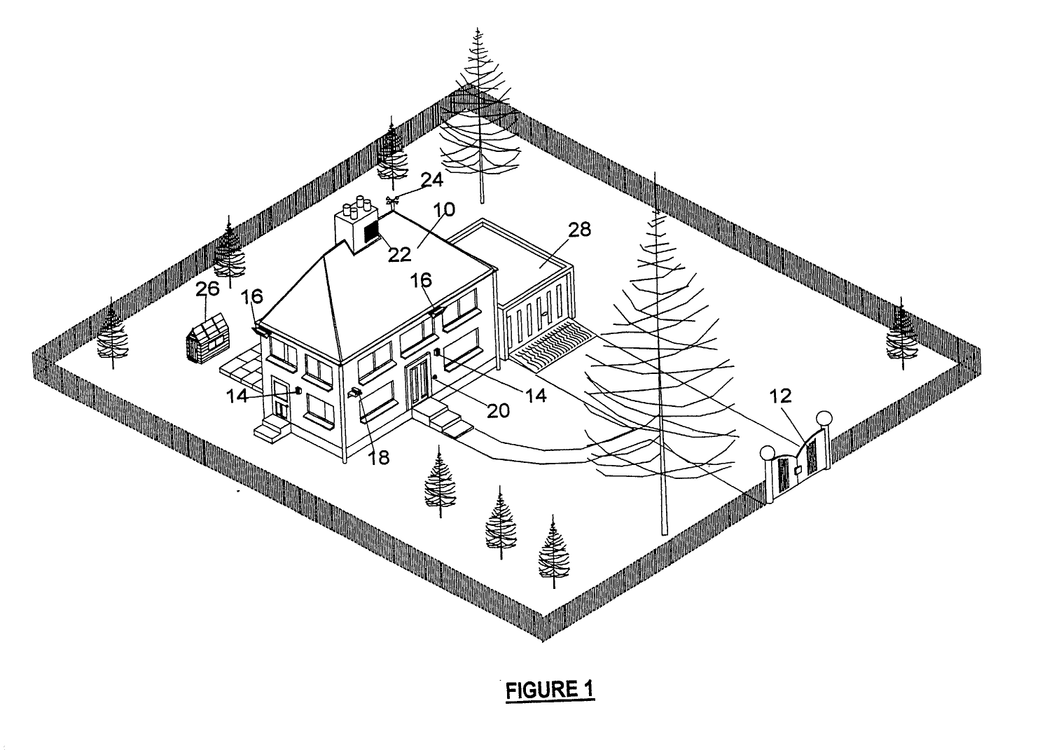

Attention is drawn to FIG. 1 showing a projected view of an exemplary dwelling according to the present invention. The house 10 is approached through an automatic self-monitoring gate 12. The gate 12 can detect when it is open or when an individual requires access through the gate 12. This information is relayed to the house 10 wherein a controller (hard processor or computer) receives the information. PIR (Passive infra-red) detectors 14, able to detect when an individual (or large animal)are in their vicinity, are attached to the exterior of the house 10 (in this instance, adjacent to the external doors) and are also linked to the central controller in the house 10. Exterior lights 16 are also attached on the outside of the house 10 and are also controlled from the central controller in the house 10. CCTV cameras (closed circuit television) 18 are also mounted on the exterior of the house 10. The CCTV camera 18, on the same face of the house 10 as the front door, is in front of the front door. Even the door bell 20 is linked to the central controller in the house 10. A daylight detector 22 communicates with the central controller to indicate whether it is bright, dull or dark outside of the house 10. The daylight detector 22 is in a position where it is not irradiated by the exterior light 16. A wind speed detector 24 indicates to the central controller in the house 10 what the exterior wind speed happens to be. The wind speed detector 24 is mounted in a position where it is able freely to have access to the wind.

The house 10 also encompasses exterior buildings such as a hut 26 and a garage 28. The exterior buildings 26, 28 are also monitored by the central controller within the house 10.

As will become apparent from the foregoing and following description, the present invention comprises a modular concept where a simple initial system can have subsequent and progressive further elements added to it to reach any degree of complexity and sophistication of which it is capable. The invention also provides the capability of connection to and co-operative action with existing networks outside of this invention.

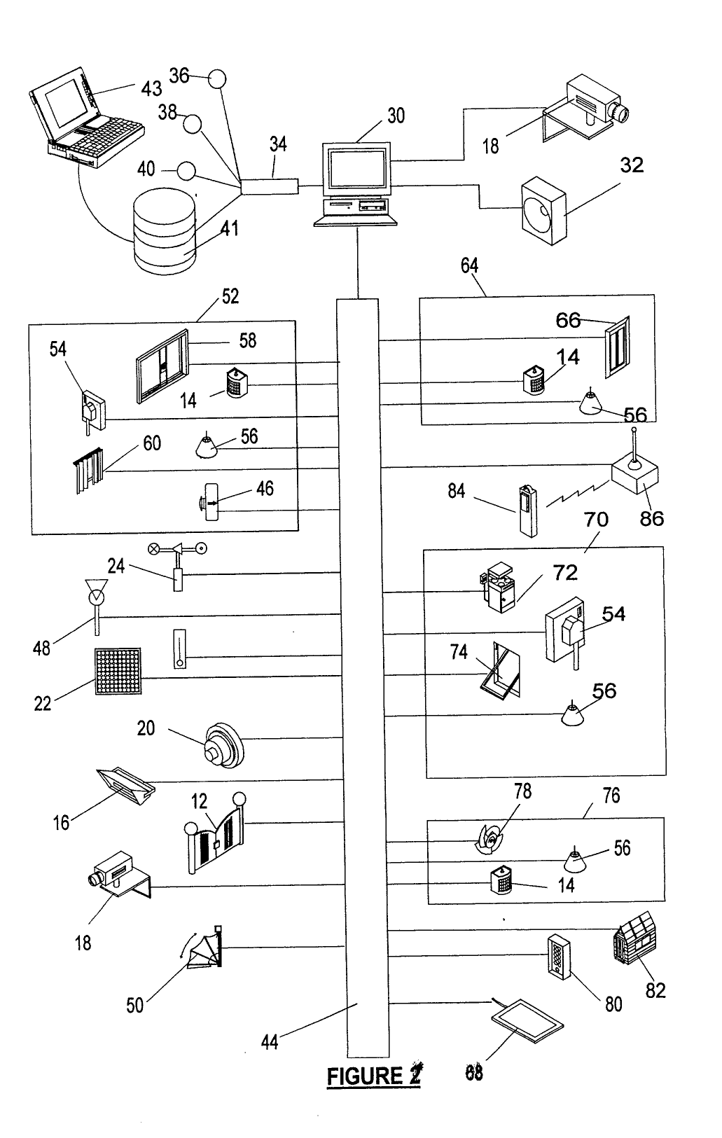

Attention is drawn to FIG. 2 showing a schematic layout of various elements within and around the house 10.

A personal computer 30 provides the central controller for the house 10. The personal computer 30 is just one example of what the central controller can be. In practise, the central controller can also be a microprocessor, a dedicated control device, or a remote link to external control and monitoring apparatus such as via the Internet, cable modems, telephony or any technology that can handle Internet of data services. All that matters is that the function of the central processor, as here epitomised by the personal computer 30, is available.

Part of the function of the personal computer 30 is to receive images from one or more CCTV cameras 18 and also to send signals to one or more loudspeakers 32 which can be situated by the doors of the house 10, and in all or any of the rooms in the house 10.

The personal computer 30 is attached to a modem 34 which allows the personal computer 30 to communicate with, for example, the house alarm company 36, friends and neighbours 38, and, again for example, one or more web sites 40 where, for example, assistance can be sought or where a two-way video conference may be conducted. Of particular interest is a control website 41 which allows a remote user 43 to receive status reports and to give control instructions to the dwelling via the personal computer 30.

The personal computer 30 is connected by an RS232 interface 42 to an in out controller 44. The in out controller 44 provides further interface between the personal computer 30 and the various elements of the present invention provided within and without the house 10.

Connected to the in out controller 44, and on the outside of the house 10, the wind speed detector 24, the daylight detector 22, a remotely readable thermometer 46 and a precipitation detector 48 all contribute to the information possessed by the personal computer 30 concerning the external environment of the house 10.

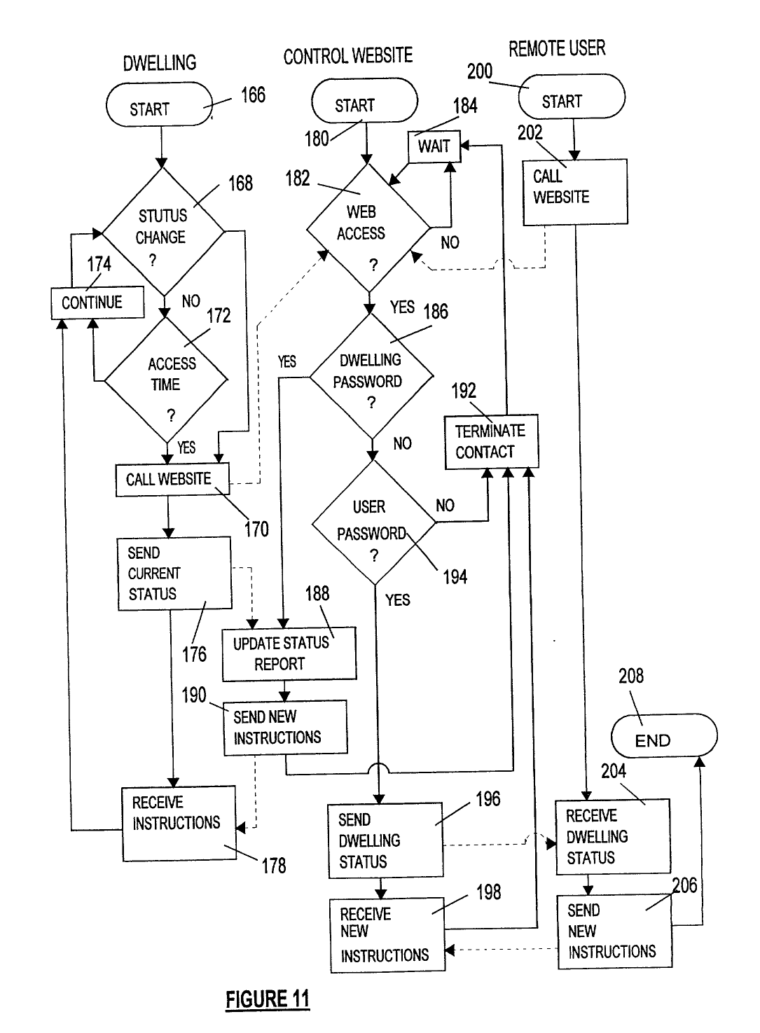

Also external to the house, the doorbell 20, the exterior lights 16, the gate 12, one or more CCTV cameras 18 and an automatic awning 50 are all connected to the in out controller 44. The CCTV cameras 18 send their images through the in out controller 44 to the personal computer 30. A TV set 51 can be connected, via the in and out controller 44, to receive and display text and visual messages received from the website 40, and in particular to receive and display messages from the control website 41 (later described in more detail) so that a remote user 43 (also later described in more detail with reference to FIG. 11) can provide news, updates and information to the house occupants. The exterior lights 16 are switched on and off by the in out controller 44. When the door bell 20 is pushed, a signal indicative thereof is sent through the in out controller 44 to the personal computer 30 which can then respond by sending sounds through the loudspeakers 32 and/or by flashing lights. As will be explained later, the awning 50 automatically deploys, under command from the personal computer 30, depending upon the weather and time and the presence of individuals outside the house 10.

In, for example, the living room 52, a PIR detector 14 detects if there is anybody present (i.e. moving, if only slightly) within the living room 52. This information is relayed back to the personal computer 30. The personal computer 30 also controls plug sockets 54 in an automatic, safety and consumption conscious manner, described hereafter. The personal computer 30 also controls the lights 56 such that a light will come on only when a compromised individual enters the living room 52, and will go off if the compromised individual leaves or ceases to move. Patio doors 58, here given as an example of an element within the living room 52, comprise detectors which communicate to the personal computer 30 if the patio doors 58 are open and if the patio doors 58 are also unlocked. Automatic curtains 60 are also controlled from the personal computer 30 and open in the mornings and close at night automatically under control from the personal computer 30. An alarm button 62 is, in this example, situated in the living room (as it might also be provided in a bedroom) so that, should anything go wrong with the compromised individual in the living room 52, a signal is sent to the personal computer 30 so that the personal computer 30 can take appropriate action, such as going for assistance via the modem 34. The modem 34 can make normal telephone calls or Internet calls or a G3 radio or a cable TV modem. If the modem 34 should fail to make a connection with the first contact on the personal computer 30's list, the modem 34 will try another. The personal computer 30 is able to distinguish messages which include recording tones, coming from the other end of the line. If the modem 34 encounters such a message, the personal computer 30 will leave its own voice message on the remote answering machine, but will be aware that this does not necessarily constitute successful delivery. The personal computer 30 will seek out a further telephone number to contact, next on the list, and so continue until a telephone number is found where no recording tones are heard when the telephone at the far end is answered.

The house 10 can comprise a hall 64 where a front door 66 is connected to the in out controller 44 to signal to the personal computer 30 to if the front door 66 is open or unlocked. A PIR detector 14 tells the personal computer 30 if a person is in the hall 64. Lights 56 are switched on, automatically, by the personal computer 30, if there is a compromised individual in the hall 64, and, optionally, if it is dark outside. Pressure mats 68 may also be provided in the hall 64, and anywhere else within the house 10 where the presence of a compromised individual should be detected. The pressure mats 68 are compressed by the weight of a person standing upon them, and signal to the personal computer 30 that an individual is compressing the particular pressure mat which is sending the signal through the in out controller 44.

As an example of thermal and electrical safety, the house 10 can comprise a kitchen 70 where a stove 72 is controlled by the personal computer 30 via the in out controller 44. The stove 72 can be switched on and switched off by the personal computer 30, in a manner described hereafter. Controlled plug sockets 54 are provided for powering kitchen appliances such as electric kettles, blenders, mixers and toasters. An automatic window 74 can be opened and closed under control from the personal computer 30, and also provides a signal to indicate to the personal computer 30 when the automatic window 74 is open and when it is unlocked. Lights 56 are also automatically controlled from the personal computer 30 in response to the state of daylight and the output of the PIR 14.

The house can comprise a bedroom 76 where a PIR detector 14 detects when a compromised individual is present and informs the personal computer 30 through the in out controller 44 for the personal computer 30 to instruct lights 56 to come on. The personal computer 30 can also instruct a fan 78 to circulate air depending upon the temperature and the presence of a compromised individual.

In addition to all these elements, there is also provided a main burglar alarm 80 which is also linked to the personal computer 30. A secondary alarm 82 is provided in the hut 26 and in any other outbuilding. When either the main burglar alarm 80 or the secondary alarm 82 goes off, the personal computer 30 employs the modem to call for assistance. The personal computer 30 sends its own voice messages so that the compromised individual within the house 10 is not required to take rational action.

Combinations of lights 56 and PIR detectors 14 can be used for automatic provision of lighting (during periods of darkness) in the outbuildings 26 28.

Compromised individuals, within the house 10, can be issued with a personal alarm 84 which, when used, sends a radio alarm signal to an alarm receiver 86 which, in turn, sends the fact of receipt of a signal from the personal alarm 84 to the personal computer 30 which then, as previously described, automatically calls for assistance.

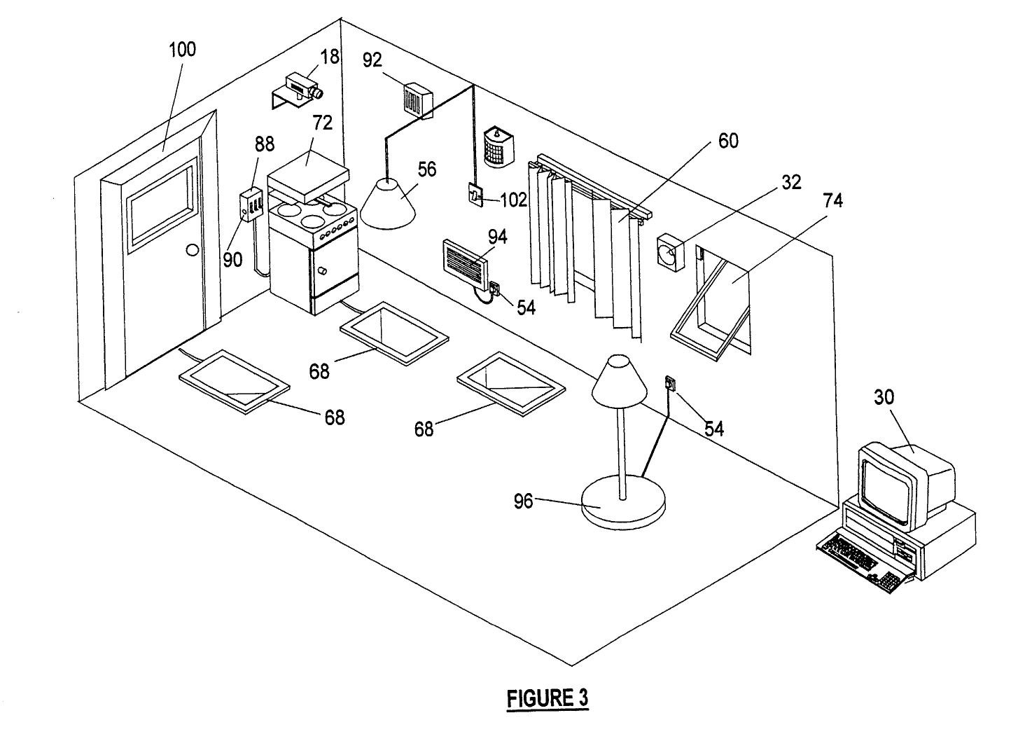

Attention is drawn to FIG. 3 showing an isometric projected view of a notional room according to the present invention.

FIG. 3 shows not any particular room, but reflects aspects to be found throughout the house 10.

The stove 72 is electrically powered under control of the personal computer 30. A PIR detector 14 detects whether a compromised individual is in the vicinity of the stove 72. Equally, a pressure mat 68 may be placed in front of the stove 72 so that, if such precautions are necessary, the compromised individual will be required to stand on the pressure mat 68 for the stove 72 to be powered. As a further precaution, a CCTV camera 18 can survey the vicinity of the stove 72 and send images back to the personal computer 30 for the personal computer to examine the image to determine if the outline of a compromised individual is visible. One, some or all of these levels can be employed in the present invention.

The stove control box 88 possesses a stove reset button 90. A compromised individual in the house 10 can use the stove 72 provided the compromised individual stays in the vicinity of the stove 72 as detected by the PIR detector 14 and/or by the CCTV camera. In extreme cases, where the compromised individual is particularly forgetful or incapable, the compromised individual may also be required to be standing upon the pressure mat 68. Should the compromised individual leave the vicinity of the stove 72 while it is switched on, the personal computer 30, after a short interval, switches off the stove 72. Should the compromised individual, or any other person, wish to resume cooking, it is necessary for the stove reset button 90 to be pushed to reactivate the stove 72. Provision of a stove 72 operating in the above described manner prevents waste of power, house fires, burned individuals, ruined food and a smoke filled kitchen. A smoke detector 92 is also connected to the personal computer 30 and indicates to the personal computer 30 if there is an accretion of smoke or fumes in the kitchen. If the smoke detector 92 detects smoke or fumes, a call is made for assistance and all equipment in the vicinity of the smoke detector 92 is shut down. Smoke detectors can be used in any room of the house in a similar manner.

Moving the imagination a little such that the room of FIG. 3 might be considered, for example, a living room, another element which is controlled by the personal computer 30 is any high temperature heating element such as an electric fire 94. There is always a risk that a compromised individual may fall asleep in front of the electric fire 94 and sustain burns, or the compromised individual may leave the electric fire 94 switched on in their absence, causing large utility bills or worse. Accordingly, the electric fire 94 is plugged into a plug socket 54 which has particular properties. Once again the PIR detector 14 detects whether or not a compromised individual is present and/or moving (even slightly) in the vicinity of the electric fire 94. A pressure mat 68 may also be employed to detect the presence of the compromised individual. Initially, the electric fire 94 is switched on simply by pressing the switch on the plug socket 54, or inserting the plug 120 into the socket 54 in the normal manner which would be used for any other electrical appliance. However, should the compromised individual fall asleep or leave the area, as detected by the PIR detector 14 failing to detect a compromised individual, or by loss of pressure on the pressure mat 68, after a predetermined period (typically five minutes) the personal computer 30 instructs the plug socket to disconnect its electrical energy from the electric fire 94. Should the compromised individual require the electric fire 94 again to provide heat, it is necessary to perform the equivalent action of switching the plug socket 54 off and switching it on again. This ensures that a human being is present at the instant when the plug socket 54 was reactivated.

A standard lamp 96 is also powered by a plug socket 54. The plug socket 54 on the standard lamp 96 is simply controlled by the personal computer 30 which allows the standard lamp 96 to be switched on at the wall or to be automatically switched on, under conditions of darkness, upon a compromised individual, introduced into the room, being detected by the PIR detector 14.

Ceiling and wall lights 56 are also switched on by the personal computer 30, when the presence of a compromised individual in the room is detected by the PIR detector, dependently upon whether the daylight detector 22 detects that it is dark outside the house 10.When the compromised individual leaves the room, the personal computer waits for a predetermined period (typically one minute) and then switches is out the lights 56.

The loud speaker 32, mounted on the wall of the room, relays sounds to the compromised individual. These sounds can include straight noises, for example, a door bell ringing, a gate bell ringing. The sounds can also include verbal messages, such as a warning that a window or door is open, that an appliance is unattended, and so on. Because the position of the compromised individual, in the house 10, is known to the personal computer by means of the PIR detectors 14, the personal computer 30 can relay the sounds or messages directly to the room where the individual is currently located. At other times, when no sounds or warnings are being deliberately relayed by the personal computer 30, the system also has the capacity to employ the loudspeakers 32 in other rooms as microphones and relay the sounds to the room where the PIR detectors 14 detect the compromised individual to be. In this manner the risk of a compromised individual failing to notice a warning or event is minimised. For deaf individuals, the loudspeakers 32 can be replaced by, or supplemented with, induction loops for direct transfer of signals to hearing aids.

Automatic curtains 60 can open automatically when it is light outside the house 10 and close when it is dark. The present invention also offers the option of only closing the automatic curtains 60 when the lights 56 are switched on in the room. The closure can be at the instant the lights 56 are switched on and the curtains 60 can remained closed for the rest of the period of darkness, or the curtains 60 can be opened again as soon as the lights 56 are switched off.

Automatic windows 74 are provided which can be opened or closed via the personal computer 30 operating an electric motor. The compromised individual merely needs to push a button to open the window 74. If the personal computer 30 detects the presence of the compromised individual, in the vicinity of the window 74, by means of the PIR detectors, and looking at various factors such as the time of day, the wind speed, the temperature, the rate of precipitation, and so on, concurs that it is acceptable to open the window, it energises the electric motor. These are just some examples of the criteria which can be used to determine whether or not to allow the opening of a window 74. None, one, some or all of them can be used. By using such criteria, it is possible to avoid inappropriate opening of windows, such as during cold weather and during storms. This has a positive impact on the physical well being of the compromised individual and on the running expenses and condition of the house 10.

Should a window 74 be left open in an unoccupied room, the personal computer 30 can be instructed to leave it open provided the climatic conditions are acceptable, that it is daylight, and that there is at least one individual in the house 10. The personal computer 30 can close the window 74 during periods of inclement weather, darkness and absence of house occupancy. In most cases, the personal computer 30 will be instructed to close the window 74 as soon as the room is unoccupied, or after a short delay. The personal computer 30 also has the option of periodically warning the compromised individual(s) that a window is left open. An open detector 98 is provided in each window 75 and provides indication to the personal computer when the window 74 is open.

An open detector can also be applied to non-automatic windows (where the window has to be opened or closed by hand). The personal computer 30 can then provide a warning to the compromised individual if a manual window is left open in an unoccupied room.

The door 100 to the room also has an open detector so that the personal computer 30 is aware when the door 100 is open. A pressure mat 68 can detect when a compromised individual enters the room (as well as the PIR 14). The personal computer 30, perhaps situated elsewhere in the house 10, is in overall control of the house 10 and its environs. Light switches 102 and switches on plug sockets 54 can be manually activated to operate or not, but when operating, the personal computer 30 assumes precautionary supervision.

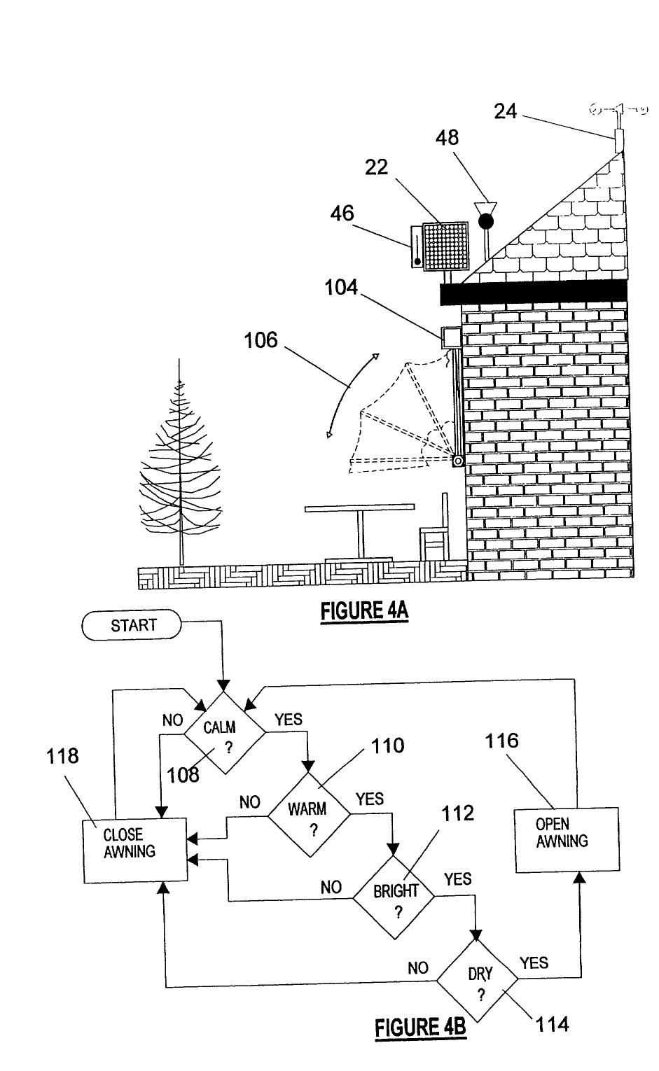

Attention is next drawn to FIG. 4A, showing an awning, on the exterior of the house 10, and to FIG. 4B, showing a flowchart of the operation of the awning.

The awning 104, attached to the side of the house 10, can be opened and closed, by electric motor, as indicated by arrow 106, under the control of the personal computer 30. The awning 104, here shown, is just an example of type. It is to be understood that the awning 104 can be any type of deployable and retractable shelter or shade located anywhere in the outdoor environment of the house 10.

The personal computer 30 consults the wind speed detector 24, the thermometer 46, the precipitation detector 48, and the daylight detector 22 to determine whether it is acceptable to have the awning 104 deployed. A first test 108 checks to see if the air is calm, that is to say that the surface air speed, as indicated by the wind speed detector 24, is below a predetermined value. If the first test 108 is satisfactory, a second test 110 tests to see if the atmosphere is warm, that is to say, that the thermometer 46 detects that the air is above a predetermined temperature. If the second test 110 is acceptable, a third test 112 checks to see if it is daylight, that is to say, that the daylight detector 22 does not detect is that it is dark. If the third test 112 is acceptable, a fourth test 114 checks to see that the weather is dry, that is to say, that the precipitation detector 48 does not detect that it is raining, hailing or snowing. Only when the fourth test 114 is satisfied, does a first operation 116 open (deploy) the awning 104. If, at any time, one of the tests 108 110 112 114 is failed, a second operation 118 closes the awning. The awning need not use all of these criteria to determine when it can deploy. Low wind speed is essential if the awning is not to be at risk of destruction by wind, though the user can select the wind speed at which deployment will be stopped. Otherwise, the user can select which criteria he will use and at what levels (brightness, temperature or precipitation) he wishes to stop deployment of the awning 104.

One very important aspect of the present invention is the manner in which the supply of power is achieved in and around the house 10. The many appliances pose different levels of potential danger and waste, depending upon the vulnerability of the compromised individuals in the house 10. Accordingly, the present invention provides more than one type of provision of power supply arrangement, one, some or all of which may prove acceptable for a particular compromised individual.

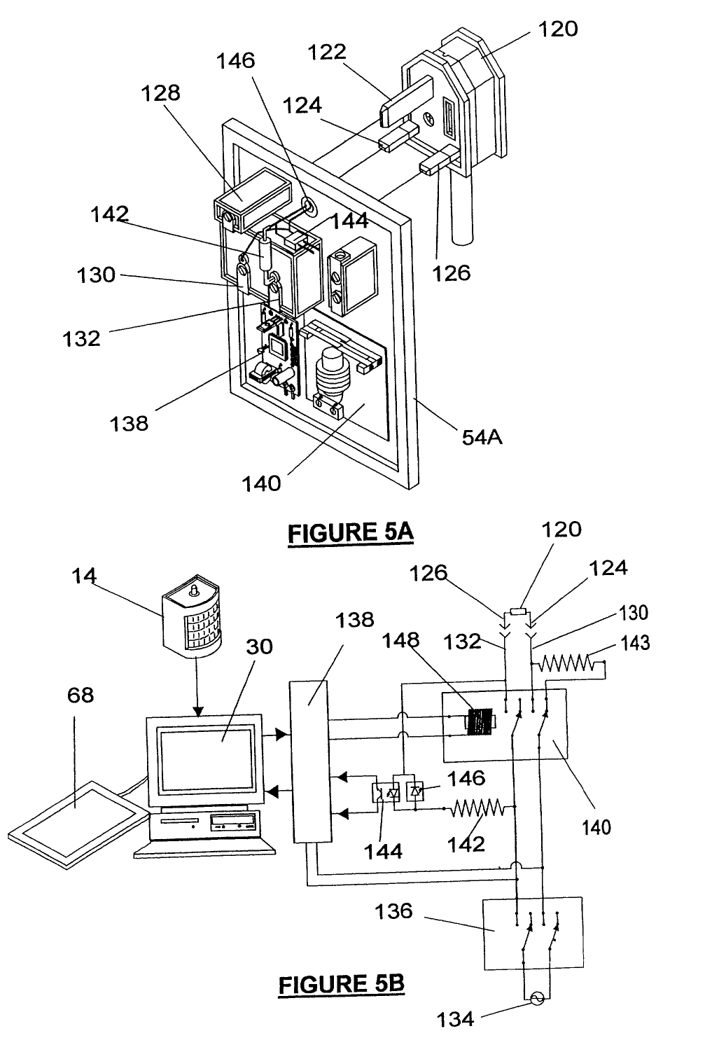

Attention is next drawn to FIG. 5A and to FIG. 5B showing, respectively, a projected view of one form of plug socket 54, according to the present invention, and a schematic diagram of the arrangement of the plug socket 54 of FIG. 5A and the personal computer 30.

A three-pin plug 120 can be inserted into a first type of three pin plug socket 54A in the conventional manner with, in this example, an earth pin 122, a line (or live) pin 124, and a neutral pin 126. These are simply given by way of example. The type of plug shown is the standard United Kingdom 13 Amp plug. As will be understood by those, skilled in the art, it is also representative of any other kind of three pin mains power supply plug used anywhere in the world. The techniques and apparatus hereafter described is equally applicable to two pin plugs (that is, those not possessing an earth pin.

The earth pin 122 inserts into an earth socket 128. The line pin 124 inserts into the line socket 130. The neutral pin 126 inserts into the neutral socket 132. The AC supply 134 is coupled to the first type of plug socket 54A via an on/off switch 136 which serves to isolate the first type of plug socket 54A, from the AC supply, when use is not required. The AC supply 134, when passed through the on/off switch 136, powers an interface card 138 which sends information to the personal computer 30 and obeys instructions sent from the personal computer 30. The plug 120 is powered, from the AC supply 134, through a double pole relay 140 when the relay 140 is energised.

Bleed resistors 142 143 are coupled in series with an optical coupler 144 and in parallel with a reverse polarised light emitting diode 146. The optical coupler 144 comprises a packaged light emitting diode and photo transistor combination. The photo transistor in the optical coupler 144 conducts whenever the light emitting diode in the optical coupler 144 glows. The photo transistor in the optical coupler 144 is electrically isolated from the light emitting diode in the optical coupler 144. The reverse polarised light emitting diode 146 serves solely to prevent the light emitting diode in the optical coupler 144 from being destroyed by the reverse voltage of the AC supply 134 when the light emitting diode in the optical coupler 144 is not conducting. Here, the light of the reverse polarised light emitting diode is put to good use as a “tell tale” indicator that the socket 54A (as will become clear in the description hereafter) has ceased suppling power because of the lack of presence of an individual. The optical coupler 144 and the reverse polarised light emitting diode 146 are together coupled in parallel at one end of the bleed resistors 142 143, and the combination of the bleed resistors 142 143 and the optical coupler 144 and the reverse polarised light emitting diode 146 are collectively situated across one of the poles of the double pole relay 140, preferably the neutral pole.

When the plug 120 is not inserted, no current flows through the bleed resistors 142 143. When the plug 120 is inserted, the electrical load conducts, allowing current to flow between the neutral pin 126 and the line pin 124 passing through the bleed resistors 142 143 and through the light emitting diode of the optical coupler 144, in sufficient quantity to cause the light emitting diode in the optical coupler 144 to glow. When the light emitting diode in the optical coupler 144 glows, it causes the photo transistor in the optical coupler 144 to conduct. When the photo transistor in the optical coupler 144 conducts, it conveys the fact to the interface card 138, which signals the fact to the personal computer 30. The personal computer 30 then instructs the interface card 138 to energise the solenoid 148 in the double pole relay 140. Thus, the double pole relay 140 is pulled into the conducting position, thus bypassing the bleed resistors 142 143 and the optical coupler 144. The personal computer 30 is coupled to the PIR detector 14 and, in some circumstances, to the pressure mat 65.The personal computer 30 maintains the current through the solenoid 148 for as long as there is a compromised individual proximate to the first type of plug socket 54A. Should the compromised individual move away from the vicinity of the first type of plug socket 54A, a timing process is commenced. Should the timing process not be complete before the compromised individual returns, the timing process is re-initialised. Should the compromised individual not return to the vicinity of the first type of plug socket 54A before the timing process is complete, the personal computer 30 de-energises the solenoid 148, thereby disconnecting the electrical load, save for the leakage current through the bleed resistor 140,which causes the light emitting diode 146 to glow, providing a tell-tale, operative so long as the plug 120 remains plugged in, that the power has been withdrawn from the plug 120 because there was not a compromised individual in the vicinity.

The personal computer 30, being the arbitor as to whether electrical power is supplied, requires, before it will restore power, that the plug 120 is withdrawn from the first type of plug socket 54A to cause the leakage current, passing through the light emitting diode in the optical coupler to fall to zero. This fact is detected by the interface card 138 as the photo transistor in the optical coupler ceases to conduct. The interface card 138 signals the fall to zero of the leakage current, followed by an subsequent rise of leakage current as the plug 120 is re-inserted, to the personal computer 23. When the leakage current re-rises, the personal computer 30 re-energises the solenoid 148 once again to supply power. This ensures that a human agency is present whenever power is supplied.

The arrangement of FIG. 5A and 5B has a further advantage. Because the bleed resistora 142 143 have a high value (the preferred value in this embodiment is a 27 Kilohm 5 watt resistor for use in a 230V RMS system), only a very small, non-lethal current can flow when the solenoid 148 is not energised. The risk of shock is eliminated

Re-activation was described, above, as being achieved by removal and re-insertion of the plug 120.It is to be understood that the present invention also encompasses re-activation using push button switches, local or remote, which temporarily break the leakage current circuit. Reactivation can also be achieved by direct commands from or to the personal computer 30, causing the solenoid 138 to be re-activated. The timing process can be located in the interface card, rather than the personal computer. The solenoid 138 can be activated by the interface card 138. The PIR detector may be directly connected to the interface card 138, thereby eliminating the need for the personal computer, and making the first type of plug socket 54A a stand alone device. Since the operation of the first type of plug socket 54A is dependent upon bleed current flowing between the two energised pins 124 126 of the plug 120, it is perfectly clear that the embodiment of FIGS. 5A and 5B is equally applicable to a two pin plug which does not possess an earth pin 122.

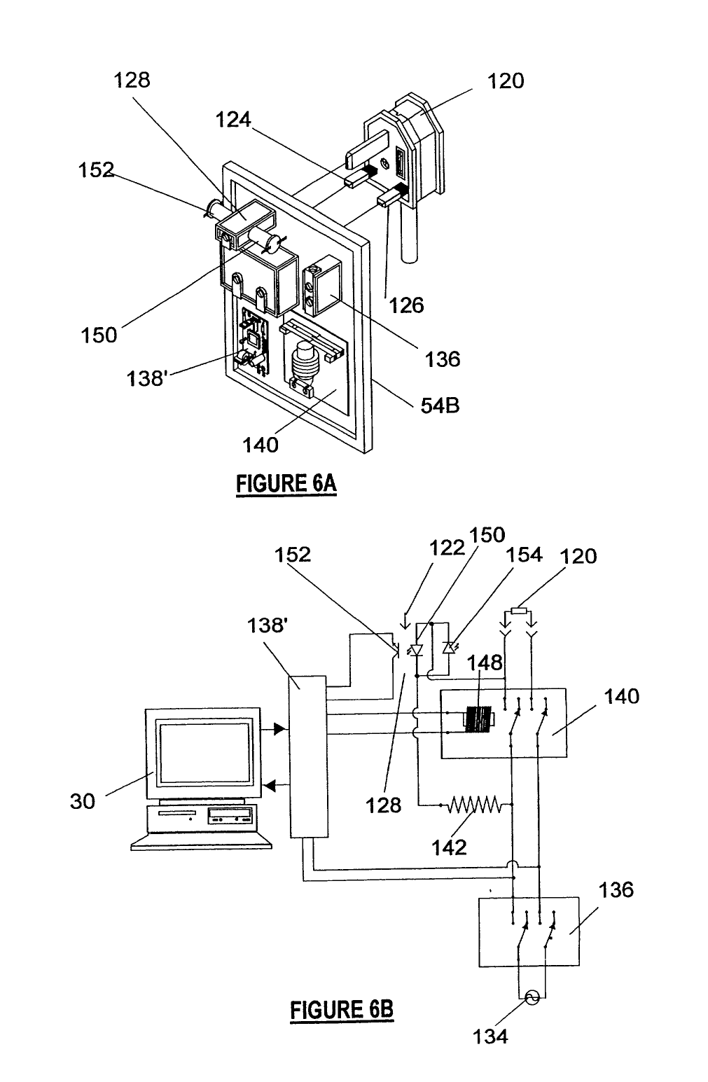

Attention is next drawn to FIGS. 6A and 6B, showing a second type of plug socket 54B consistent with the present invention. Everything of like number is of the same nature as shown in FIGS. 5A and 5B. Instead of an optical coupler 144, an earth pin light emitting diode 150 is disposed on one side of the earth socket 128 and an earth pin photo transistor 152 is disposed on the other side of the earth socket 128. A reversed polarised diode 154 prevents the earth pin light emitting diode 150 from being destroyed by reverse voltage. The bleed resistor 142 is wired between the neutral socket 132 and the line socket 130 so that the earth pin light emitting diode 150 is lit at all times the switch 136 is switched on. The modified interface card 138′ detects the current flowing through the earth pin photo transistor 152, induced by the incidence thereon of light from the earth pin light emitting diode 150, and signals the fact to the personal computer 30. The personal computer 30 keeps the solenoid 148 de-energised until the earth pin 122 is inserted into the earth socket 128. This action stops the light from the earth pin light emitting diode 150 falling upon the earth pin photo transistor 152. This is detected by the modified interface card 138′ and signalled to the personal computer 30, which energises the solenoid 146. Once again, as for the description of FIGS. 5A and 5B, the personal computer 30 switches off the power to the solenoid 148 a short time after the compromised individual leaves the vicinity of the second type of plug socket 54B, and will only permit the plug 120 to be re-energised if the switch 136 is switched off and on again, de-powering and re-powering the interface card 138, which is detected by the personal computer 30 which then knows that an individual is present, permitting the personal computer 30 to re-energise the solenoid 148. The earth pin 122 is used in this example to shut out light. It is clear that either of the other two pins 124 126 could equally have been used in its place, and that the technique can be applied to two pin plugs, having no earth pin 122, but, instead, using one of the energised pins 124 126.

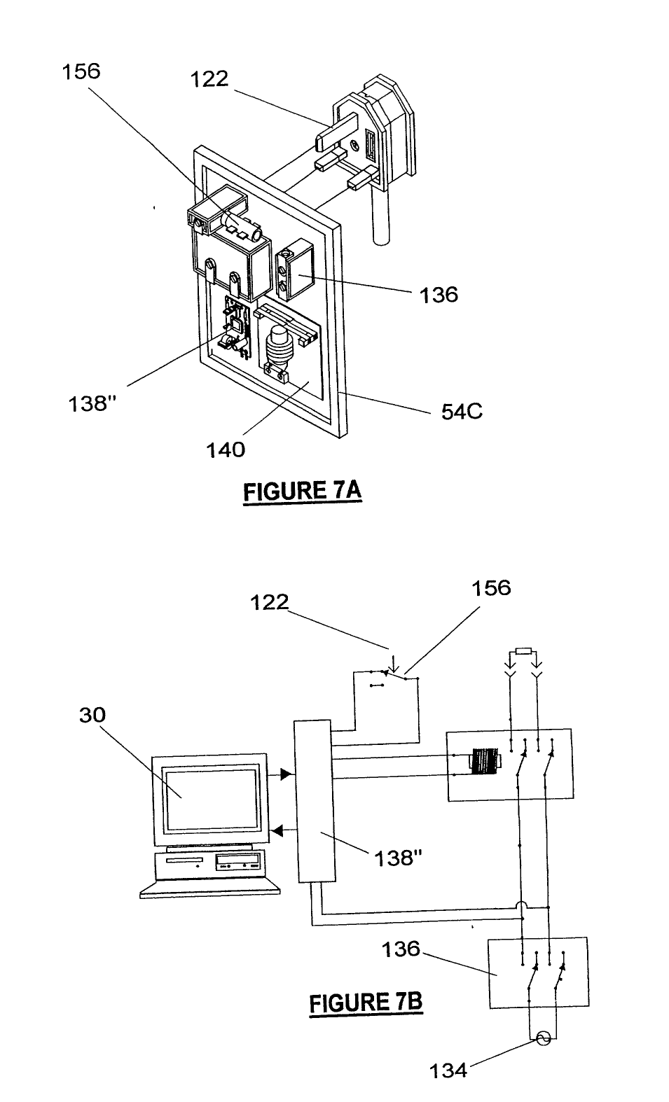

Attention is next drawn to FIGS. 7A and 7B, showing a third type of plug socket 54C consistent with the present invention.

The earth pin 122 of the plug 120 is inserted into the earth socket 128 to displace a switch 156. When displaced, the switch makes a circuit, which is detected by the interface card 138″ and the fact relayed to the personal computer 30, which, in turn, instructs the interface card 138″ to energise the solenoid 148 to operate the relay 140. The personal computer 30 exercises the same control sequence as for the provision of power to the plug 120 as in the examples of FIGS. 5A 5B 6A and 6B. In this instance, the plug 120 must be withdrawn and re-inserted before power will be restored, or, as an alternative, a momentary-break push switch can be used in series with the switch 156 to break the circuit to the interface card 138″ to inform the personal computer 30 that the individual has returned. The switch 156 can, equally, be applied to either the line socket 130 or the neutral socket 132, and can be employed on a two pin plug without an earth pin 122.

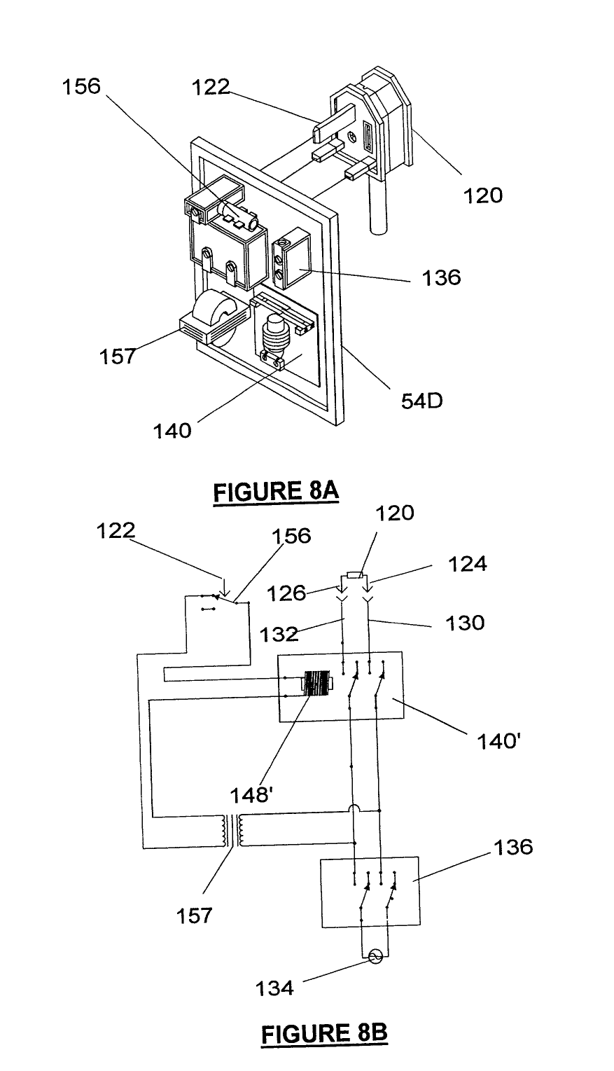

Attention is next drawn to FIGS. 8A and 8B, being, respectively, a projected view of a fourth type of plug socket 54D, according to the present invention, together with a wiring diagram thereof. This is the simplest form of plug socket, being operative only to disconnect itself from the AC supply 134 when no plug 120 is inserted, thus making it proof against individuals (typically small children) who are inclined to poke objects or fingers into a plug socket 54D or even to engage a plug socket with their mouths or tongues. This same apparatus is applicable to any outdoor or wet application, such a building sites, marine sites and general industrial situations.

A switch 156 is operated by insertion of the earth pin 122 to provide power a 6/12 Volt solenoid 148′ on a relay 140′ in a low voltage circuit powered via a transformer 157 driven by the AC supply 134. The relay 1401 thus only supplies voltage to the line socket 132 and the neutral socket 130 when the plug 120 is inserted. If the plug 120 is removed, the voltage is automatically s removed from the line 132 and neutral 130 sockets, rendering the plug socket 54D harmless. The switch 156 can, equally, be applied to either the line socket 130 or the neutral socket 132, and can be employed on a two pin plug without an earth pin 122.

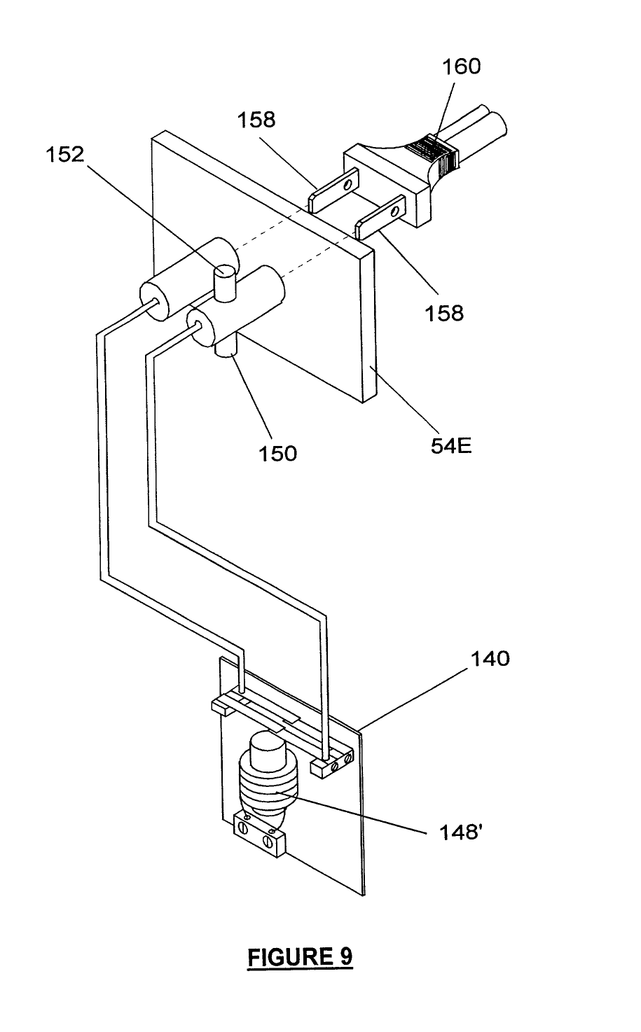

Attention is next drawn to FIG. 9, showing an example of a two-pin plug and a two pin plug socket 54E with an added improvement.

One of the pins 158 on the two pin plug 160 breaks the light path between a light emitting diode 150′ and a photo transistor 152′ to cause de-energisation of a solenoid 148′ via a low voltage circuit. The solenoid 148′ operates a relay 140 to supply AC power to the two pin plug 160. There is no voltage on the pins 158 of the two pin plug 160 until the light path is broken. The relay 14 can be located at a great distance from the two pin plug socket 54E, perhaps even as far away as the distribution box for the AC supply, thus rendering the entire length of the cabling to the two-pin plug socket 54E protected.

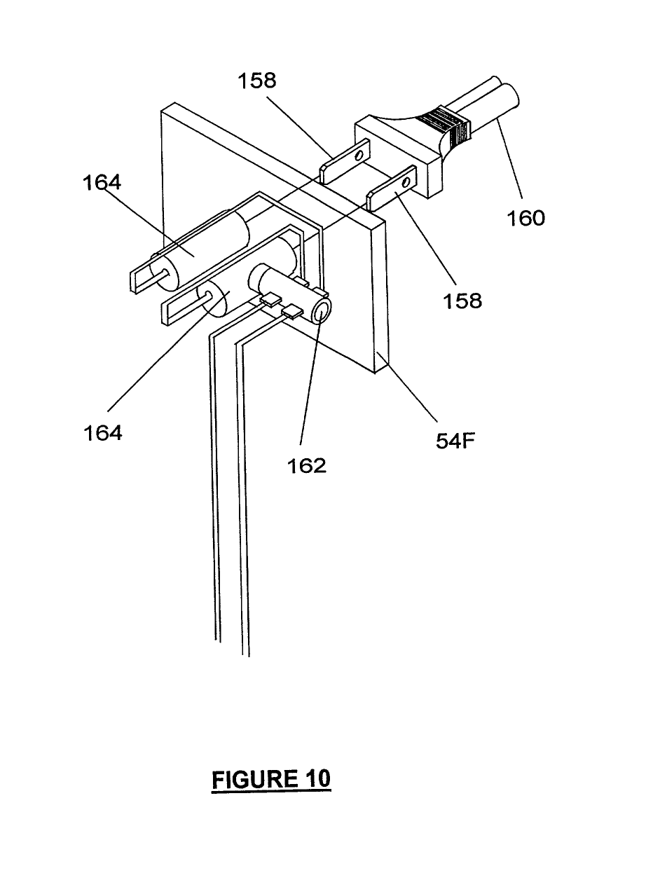

Finally, attention is drawn to FIG. 10, showing another variant of the plug socket 54E according to the present invention. Here, a double pole switch 162 is operative to connect each side of the AC supply 134 to a respective one of the sockets 164 when the switch 162 is operated by the insertion of one of the pins 158 of the two pin plug 160 into one of the sockets 164.The switch is well insulated, thus effectively completely isolating the two pin socket 54F from the AC supply 134 whenever the two pin plug 160 is removed.

The techniques, according to the present invention, employed for the control of the plug sockets 54X, are also employed for the stove 72. The apparatus of FIG. 5B is ideal for this purpose, with the stove reset button 90 being used to break the circuit carrying the bleed current, so that the personal computer 30 knows that an individual has returned.

Attention is drawn to FIG. 11, showing the activities of the dwelling in the form of the personal computer 30, of the control website 41, and of the remote user 43 as the house 10 is monitored and controlled remotely, in this instance from any part of the world. It is to be understood that the website can equally be replaced by any other data exchange site which can be reached by a remote user 43 and in turn, with or without a modem 34, can be reached by the house 10 in the form of the personal computer 30.It is also envisaged that the invention encompasses a remote website 41 which is a common Internet resource, shared by many (perhaps thousands to hundreds of thousands)remote users 43, each remote user 43 being uniquely identified by the remote website 41 and each remote user, on the basis of the identification, being permitted monitoring and controlling access to a specified single dwelling or facility.

The dwelling, from a start 166, uses a first test 168 to see if any parameters in the settings of the control of the house have altered. If an alteration has occurred, control is passed to a first operation 170 which calls the control website 141. If the first test 168 has detected no status change, a second test 172 checks to see if a regular time has occurred when the house 10 in the form of the personal computer 130 is due to check into the control website 41. If an access time has not been reached, control is passed back to a second operation 174 which simply allows the personal computer 30 to continue controlling the house 10 in a regular manner.

The personal computer 30, having called the control website 41 in the first operation 170, goes on in a third operation 176 to report the current status of the house 10 and, in a fourth operation 178, to receive any new instructions from the remote user 43. Thereafter control is returned to the second operation 174 for the personal computer 30 to continue running the house 10 and to stand ready, at a status change or at an access time, to call the control website 41.

The control website 41, in a start 180, passes control to a third test 182 where the control website 41 checks to see if it is being accessed either by the personal computer 30 via the modem 34 or by the remote user 43, again using a computer and a modem. If no web access is required, a fifth operation 184 continues waiting until access is required. If access is required, a fourth test 186 checks to see if the device accessing the control website 41 is able to give the appropriate password for the dwelling (house 10). If it is, control is passed to a sixth operation 188 which receives the current status report of the dwelling from the third operation 176, and is passed, thereafter, to a seventh operation 190 which sends any new instructions required to be obeyed by the dwelling, via the fourth operation 178. Thereafter, an eighth operation 192 terminates the contact and returns control to the fifth operation 184 where the control website 41 waits for further internet access.

If the fourth test 186 has failed to detect a dwelling password, a fifth test 194 checks to see if a password is present, authorising the remote user 43. If there is none, control once again passes to the eighth operation 192 where the contact is terminated and, thereafter, the fifth operation 184 where the control website 41 awaits further access via the internet.

If the fifth test 194 detects a password authorising the remote user 43, control passes to a ninth operation 196 where the control website 41 sends the latest dwelling status report to the remote user 43. Thereafter, a tenth operation 198 receives any new instructions from the remote user 43. After that, control is passed once again back to the eighth operation 192, where the contact is terminated and, thereafter, is passed to the fifth operation 184 which causes the control website 41 to wait for further internet access.

The remote user 43, from start 200, in an eleventh operation 202, calls the control website 41. Once contact has been established, a twelfth operation 204 has the remote user 43 receive a report on the latest status of the dwelling from the ninth operation 196 of the control website 41. The control website, via a thirteenth operation 206 of the remote user 43, also receives, via the tenth operation 198 of the control website, 41 any new instructions, given by the remote user 43, to be adopted by the dwelling (house 10). Thereafter, the activity of the remote user 42 comes to an end 208.

In operation, from time to time, on status changes or at regular access times, the personal computer 30 reports in to the control website 41 to report the current status of the house 10. The control website 41 stores the current status of the house 10 until the stored status report is updated by a later status report from the house 10. The remote user 43 can visit the control website 41 to discover the current (latest reported) status of the house 10. The personal computer 30 can also, on visiting the control website 41, receive any new instructions for the control of the house 10 which may, since the personal computer 30 last visiting the control website 41, have been left by the remote user 43, stored in the control website 41, to later be retrieved by the personal computer 30.

From time to time, whenever the individual requires, the remote user 43 will check in to the control website 41 to see what is going on at the house 10. The remote user 43 will pick up the most recently deposited status report, received from the personal computer 30, and will, if required, send new instructions to be stored at the control website 41 until picked up by the personal computer 30 in the house 10 via the modem 34 and the control website 41.

The control website 41 can present to the user 43 a series of screens and reports with items that can be read and changed if required. Such items as the opening or closing of doors or windows, or the control of temperature, lights or curtains, or the availability of heating or cooking utensils, may all be controlled. Furthermore, the time at which heating comes on or goes off, or the time that lights are illuminated or switched off, or the time that curtains are opened or closed, can all be altered by the remote user 43 communicating with the personal computer 30 through the control website 41. In fact, any device can, potentially, be controlled via the control website 41, right down to flushing of toilets, turning on and off of taps, sprinkling the lawn, turning off and on individual electrical sockets, and so on.

The remote user 43 and the personal computer 30 can access the control website 41 at different times, as described. The present invention encompasses a further mode of co-operation among the personal computer 30, the control website 41 and the remote user 43 where the remote user 43 and the personal computer 30 are simultaneously coupled to the control website, permitting real time changes in the status of the house 10 to be monitored in response to instructions, provided by the remote user 43. In this way, a rapid means is provided whereby the functionality or non functionality of controllable elements, within the house 10, can be tested and ascertained.

The remote user 43 can use the control website 41 to override local control decisions, made automatically by the personal computer 30. For example, the personal computer 30 may elect, for the good conduct of the household, to switch off some lights. The remote user 43 may wish to keep them on for a specified time. The remote user can communicate his wishes and times to the personal computer 30, which will comply.

The present invention also provides for the application of one, some or all of the techniques and apparatus described and claimed herein.

1. A system for controlling the surroundings of a compromised individual, said system comprising; means to monitor the location of the compromised individual; means to activate equipment, associated with the well being of the compromised individual, in the presence of the compromised individual; and means to de-activate equipment, associated with the well being of the compromised individual, in the absence of the compromised individual.

2. A system, according to claim 1, comprising means to monitor the activity of the compromised individual, means to assess the probity of the activity of the compromised individual, and means to direct the activity of the compromised individual towards probity, said means to direct the activity of the compromised individual towards probity including at least one of; means to remind the compromised individual of a necessary action; and means to deny the compromised individual the execution of an action.

3. A system, according to claim 2, wherein said means to remind the compromised individual of a necessary action comprises at least one of; means to remind the compromised individual to return to an unattended appliance, means to remind the compromised individual to close an unattended window, means to remind the compromised individual to close an unattended door, and means to remind the compromised individual to close an unattended gate.

4. A system, according to claim 2 or claim 3, wherein said means to deny the compromised individual the execution of an action comprises means to monitor the prevailing environmental conditions and to deny the execution of the action if the prevailing environmental conditions are incompatible with the proposed action, deniable actions comprising at least one of; opening of a window, deployment of an awning, opening of curtains, closing of curtains, closing an unattended window, closing an unattended door and closing an unattended gate.

5. A system, according to claim 1, claim 2, or claim 3, wherein said means to monitor the location of the compromised individual comprises at least one of; a passive infra red detector, a pressure mat, and a closed circuit television camera.

6. A system, according to any one of claim 1, claim 2, or claim 3, wherein said equipment, which can be activated in the presence of the compromised individual, includes at least one of: local lighting, local air circulation, and a local loud speaker.

7. A system, according to any one of claims 1 to 3, wherein said equipment which can be de-activated in the absence of the compromised individual includes at least one of; an electric fire, an electric stove, an electric kitchen appliance, an electric domestic laundry appliance, and an electric lamp.

8. A system, according to any one of claims 1 to 3, comprising a controller for monitoring the surroundings and responding thereto to activate and de-activate equipment, said controller being further operative to receive an alarm call from the compromised individual, and to respond thereto by summoning help by means including means to make a prerecorded telephone call by telephoning one or more telephone numbers on a predetermined list until at least one telephone number has been contacted.

9. A system, according to any one of claims 1 to 9, comprising monitoring and control means, operative to allow a remote user to access the dwelling to determine the status of the dwelling and to adjust the controls in the dwelling, said monitoring and control means comprising a common web site, accessible by the remote user to receive a report of status and for the remote user to give instructions intended for the dwelling; and accessible by said dwelling to report status, and for the dwelling to receive instructions.

10. A system, according to claim 9, wherein said dwelling is operative to send a picture to said common data site from a selectable camera in said dwelling, and wherein said remote user can access said common data site to view the picture.

11. A system, according to any one of claims 1 to 3, wherein said means to de-activate equipment in the absence of the compromised individual comprises means to disconnect the electricity supply from the electrical outlet powering the equipment.

12. A system, according to claim 11, wherein said means to disconnect the electricity supply from the electrical outlet powering the equipment comprises a switch, operable by the insertion of a plug into a socket, to connect the electricity supply to the socket, said switch being operative to couple the electricity supply either directly to the socket or to operate a relay, the relay being operative to couple the electricity supply to the socket.

13. A system, according to claim 11, wherein said means to de-activate equipment in the absence of the compromised individual comprises means to disconnect the electricity supply from the electrical outlet powering the equipment, including a light path, breakable by the insertion of a plug into a socket, the breaking of the light path causing the operation of a relay to connect the electricity supply to the socket.

14. A system, according to claim 11, wherein said means to de-activate equipment in the absence of the compromised individual comprises means to disconnect the electricity supply from the electrical outlet powering the equipment, includes a bleed current supply through the equipment and a bleed current detector in association with the socket, detection of the flow of bleed current causing the operation of a relay to connect the electricity supply to the socket.

15. A system, according to claim 14, wherein said bleed current detector comprises an optical coupler.

16. A system, according to claim 11, wherein said means to disconnect the electricity supply from the electrical outlet powering the equipment comprises means to re-connect the electricity supply, operable only in the presence of the compromised individual, said means to re-connect the electricity supply comprising at least one of; a manually operable switch, a passive infra red detector, a pressure mat, and a closed circuit television camera.

17. An electrical socket, for protection of a compromised individual, including means to disconnect the electricity supply from said electrical socket when a plug is absent from the socket,
said means to disconnect the electricity supply from the electrical socket when a plug is absent from the socket comprising a switch, operable by the insertion of a plug into said socket, to connect the electricity supply to said socket,
said switch being operative to execute at least one of; couple the electricity supply directly to said socket, and operate a relay, the relay being operative to couple the electricity supply to said socket.

18. An electrical socket, for protection of a compromised individual, including means to disconnect the electricity supply from said electrical socket when a plug is absent from the socket, said means to disconnect the electricity supply from said electrical socket when a plug is absent from the socket comprising a light path, breakable by the insertion of a plug into said socket, the breaking of the light path causing the operation of a relay to connect the electricity supply to said socket.

19. An electrical socket, for protection of a compromised individual, including means to disconnect the electricity supply from said electrical socket when a plug is absent from said socket, said means to disconnect the electricity supply from said electrical socket when a plug is absent from said socket comprising a bleed current path through electrical equipment to be supplied by said socket and a bleed current detector in association with said socket, detection of the flow of bleed current causing the operation of a relay to connect the electricity supply to said socket.
